(19) United States
(12) Patent Application Publication
(10) Pub. No.: US 2002/0129112 A1
(43) Pub. Date: Sep. 12, 2002

(54) Teleconferencing method and system

(75) Inventor: Kazutoyo Maehiro, Tokyo (JP)

Correspondence Address: GREENBLUM & BERNSTEIN, P.L.C., 1941 ROLAND CLARKE PLACE, RESTON, VA, 20191, US

(73) Assignee: SQUARE CO., Ltd., Tokyo (JP)

(21) Appl. No.: 10/084,332

(22) Filed: Feb. 28, 2002

(30) Foreign Application Priority Data
Mar. 1, 2001 (JP) 2001-057492

(51) Int. Cl. G06F 15/16; H04L 12/16; A63F 9/24; G06F 19/00; G06F 17/00

(52) U.S. Cl. 709/207; 370/260; 463/1

(57) ABSTRACT

A source terminal adds to a message a header including a flag indicating whether the message is private communication and information for identifying a recipient of the message and sends the message to a server. The recipient terminal displays the message received from the server, to which the flag is added, along with information indicating that the message is a private communication.

The present disclosure relates to subject matter contained in Japanese Patent Application No. 2001-057492, filed on Mar. 1, 2001, the disclosure of which is expressly incorporated herein by reference in its entry.

### BACKGROUND OF THE INVENTION

1. Field of the Invention

The present invention relates to teleconferencing, and more particularly, to allowing private communications among arbitrary participants in a teleconference.

2. Description of the Related Art

An Internet connection function installed in a video game machine can provide various services through an Internet service provider (ISP) server. New services may be provided such as distribution of game software and implementation of a fighting game over a network. On the other hand, combination between a service such as e-mail and teleconferencing (called chat hereinafter) and a service relating to games, both of which have been conventionally provided over the Internet, may provide newer services.

In the fighting game, one user can play with another user over a network as an opposing enemy or a friend who fights together. If users who know each other through the game have a medium to communicate with each other, they can exchange information regarding the game, which may increase the nature of entertainment in the game. Further, if multiple participants rather than two participants in the one-to-one fighting game can participate in the game at the same time, information exchange through the chat may be more effective. In order to establish the chat session, a starter or one of the participants sends a message to a chat room and a server in response thereto broadcasts the message to the other starter or participants.

However, a conventional chat service only broadcasts the chat message to all of the participants in the same chat room but cannot send the chat message only to specific participants in the chat room during chatting. In order to send a message only to specific participants, an extra application such as e-mail must be used.

### SUMMARY OF THE INVENTION

The present invention was made in view of such a problem. It is an object of the present invention to provide a method and a system for teleconferencing, which allow private communication among arbitrary participants in a teleconference through easy processing during the teleconference.

According to one aspect of the present invention, there is provided a teleconferencing method for performing a teleconference by using an area set in a database in a server. The method includes causing a source terminal to add to a message a header, including a flag indicating whether the message is sent as private communication and information for identifying a recipient of the message, and to send the message to the server. The method also includes causing the server to transfer the message, to which the flag is added, to the recipient terminal based on the information identifying the recipient. The method further causes the recipient terminal to display the message transferred from the server terminal, along with information indicating the private communication.

According to another aspect of the present invention, there is provided a message control method for causing a server to provide a private communication service in a teleconference. The method includes receiving a message from a source terminal, to which message a header including a flag indicating whether the message is sent as the private communication and information for identifying a recipient is added. The method also includes transferring to the recipient terminal a received message to which the flag indicating the message is sent through the private communication is added, based on the information identifying the recipient.

According to another aspect of the present invention, there is provided a message control method for performing private communication among terminals participating in a teleconference by using an area set in a database in a server. The method includes causing a source terminal to add to a message a header, including a flag indicating whether the message is sent as private communication and information for identifying a recipient of the message, and to send the message to the server. The method also includes causing the recipient terminal to display the message transferred from the server terminal, along with information indicating the message is sent as private communication.

In this case, the source terminal receives a private communication selection as to whether the message is sent as the private communication and a recipient selection indicating the recipient of the message transferred through the private communication, and creates the header based on the private communication selection and the recipient selection.

In the message control method, the recipient terminal displays the message, to which the flag indicating that the message is sent through the private communication is added, and the information that the message is sent through the private communication on the same display area where a general message is displayed.

According to another aspect of the present invention there is provided a teleconferencing system for performing a teleconference by using an area set in a database in a server. A source terminal includes a sending system that sends a message to the server, while adding a header including a flag indicating whether the message is sent as private communication and information for identifying a recipient of a message to the message. The server includes a transferring system that transfers to the recipient terminal the message to which the flag is added, based on the information identifying the recipient. The recipient terminal includes a display system that displays the message transferred from the server terminal, along with information indicating the message is sent as the private communication.

According to another aspect of the present invention, there is provided a server for providing a private communication service in a teleconference. The server includes a receiver that receives from a source terminal a message, to which a header including a flag indicating whether the message is sent as the private communication and information for identifying a recipient. The server also includes a transferring system that transfers to the recipient terminal a received message, to which the flag indicating the message is sent as the private communication is added, based on the information identifying the recipient.

According to another aspect of the present invention, there are provided terminals participating in a teleconference by using an area set in a database in a server. A source terminal includes a sending system that sends a message to the server, while adding to the message a header including a flag indicating whether the message is sent as private communication and information for identifying a recipient of the message. A recipient terminal includes a display system that displays the message transferred from the server terminal, along with information indicating the message is sent as private communication.

According to another aspect of the present invention, there is provided a computer-readable recording medium on which is recorded a program for controlling a server for providing a private communication service in a teleconference. The program causes a computer to receive from a source terminal a message, to which a header is added including a flag indicating whether the message is sent as private communication and information for identifying a recipient, and transfer to the recipient terminal the received message to which the flag indicating that the message is sent as private communication is added, based on the information for identifying the recipient.

According to another aspect of the present invention, there is provided a computer readable recording medium on which is recorded a program for controlling a terminal for performing a private communication service in a teleconference. The program causes a computer to send to the server a message, while adding to the message a header including a flag indicating whether the message is sent as private communication and information for identifying a recipient of the message. The program also causes the computer to display the message received from the server, along with information that the message is sent as private communication.

In the computer-readable recording medium, when sending the message to the server, the computer accepts a private communication selection indicating whether the message is sent as private communication and a recipient selection indicating a recipient of the message in the private communication, and creates the header based on the private communication selection and the recipient selection.

According to another aspect of the present invention, there is provided a teleconferencing method for performing a teleconference including a server and multiple terminals. The method causes the server to transfer a message sent from one of the terminals to the other terminals, causing each of the other terminals to display cumulatively a scrolled message display screen each time the transferred message is received. The method also causes a source terminal to accept a private communication selection indicating whether the message is sent as private communication and a recipient selection indicating the recipient of the message in the private communication, and to create and to send a privacy message if there is the private communication selection or a general message if there is not the private communication selection. The method further causes the server to transfer the general message to all of the terminals participating in the teleconference or to transfer the privacy message to the recipient terminal, and causes the terminal to display the general message on a display area of the message display screen or to display the privacy message on the display area along with information that it is a private communication.

Thus, the private communication can be performed among arbitrary participants in a teleconference through easy processing by using a video game machine.

### BRIEF DESCRIPTION OF THE DRAWINGS

FIG. 1 is a structural diagram showing a system for teleconferencing, according to one embodiment of the present invention;

FIG. 2 is a block diagram showing a video game machine in which teleconferencing according to one embodiment of the present invention is implemented;

FIG. 3 is a sequence diagram showing a method for participating in a teleconference, according to one embodiment of the present invention;

FIG. 4 is a flowchart showing a private communication method in a teleconference, according to one embodiment of the present invention;

FIG. 5 is a diagram showing a communication data format for a message in a teleconference, according to one embodiment of the present invention;

FIG. 6 is a diagram showing a chat screen, according to one embodiment of the present invention;

FIG. 7 is a diagram showing a message creating screen, according to one embodiment of the present invention;

FIG. 8 is a diagram showing a chat screen displayed in response to the receipt of a message through a private communication method; and

FIG. 9 is a flowchart showing another private communication method in a teleconference, according to one embodiment of the present invention.

### DESCRIPTION OF THE PREFERRED EMBODIMENTS

Embodiments of the present invention will be described below in detail with reference to drawings.

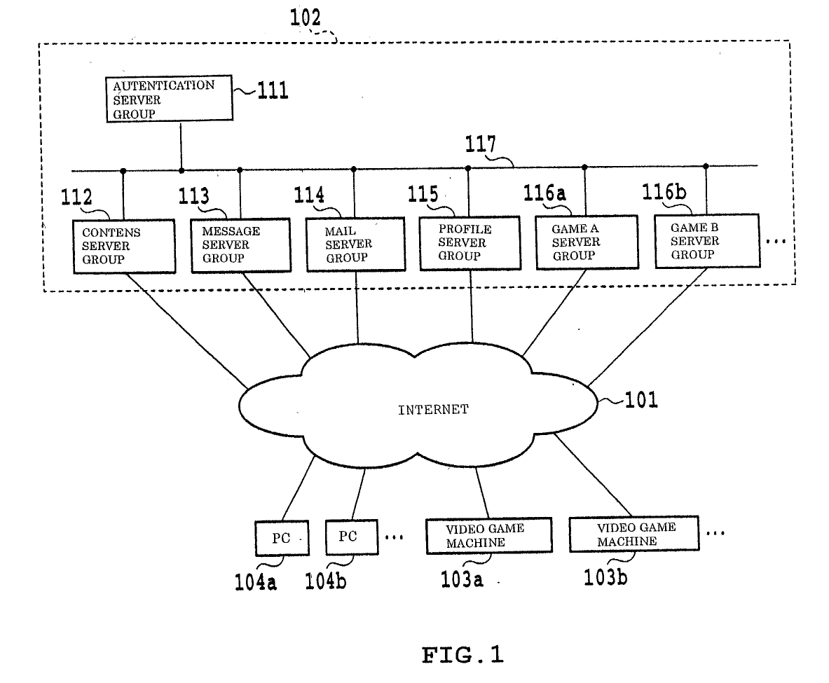

FIG. 1 is a structural diagram showing a system for providing a teleconference, according to one embodiment of the present invention. FIG. 1 includes an Internet 101 to which an ISP server 102, video game machines 103a and 103b and generic computers 104a and 104b are connected.

The ISP server 102 includes multiple server groups. For example, an authorization server group 111 may be provided for performing account management for user authorization. A content server group 112 may provide a service for viewing content such as voice and moving pictures, and a message server group 113 may provide an environment for chat and/or messaging. A mail server group 114 may provide e-mail services, a profile server group 115 may be provided for managing user profiles, and game server groups 116a and 116b may provide a game environment. All of the server groups are connected via a LAN 117.

In order to obtain authorization under the configuration, a user can access from the video game machine 103a or 103b or generic computer 104a or 104b the authorization server group 111 in the server 102 through the Internet 101. The server 102 sends a menu screen to the authorized user. The user may select one of services displayed on the menu screen. In response to the selection, the video game machine 103a or 103b or generic computer 104a or 104b is connected to a server group corresponding to the selected service. Then, the user can receive the service.

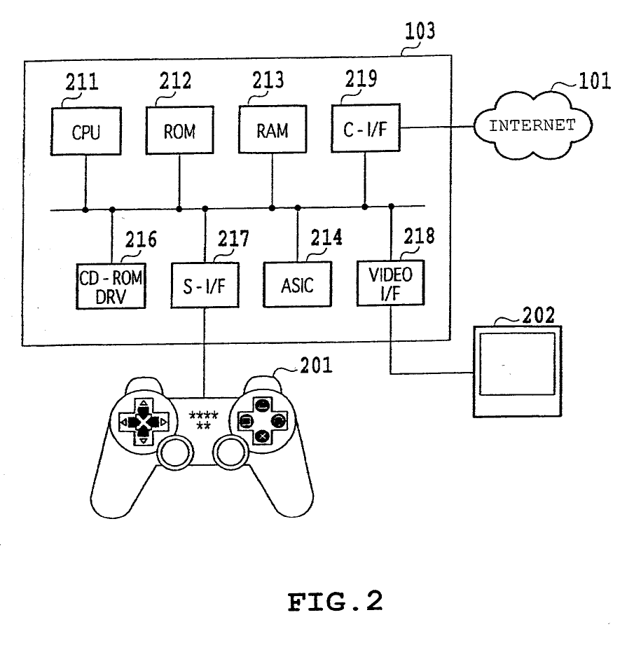

FIG. 2 is a block diagram showing a video game machine in which teleconferencing, according to one embodiment of the present invention, is implemented. In a video game machine 103, a CPU 211 for performing the entire control, a ROM 212 in which game programs and programs for message control according to the present invention are stored, a RAM 213 which is a temporary memory area, and an application-specific integrated circuit (ASIC) 214 for performing image processing are connected through a bus 215.

Further, a CD-ROM drive 216 for reading programs from a CD-ROM in which the game programs and the programs for the message control are stored, is also connected to the bus 215. Moreover, a serial interface 217 connected to a game controller 201, a video interface 218 connected to a television monitor 202, and a communications interface 219 for connecting to the Internet 101 are connected through the bus 215.

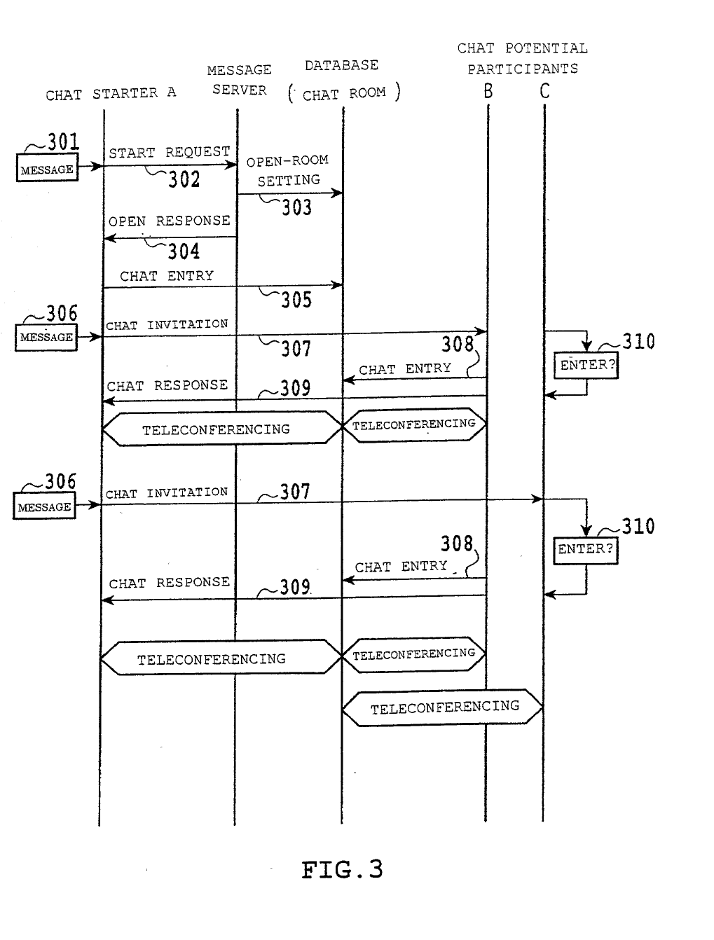

FIG. 3 is a sequence diagram showing a method for participating in a teleconference according to one embodiment of the present invention. A user starting a chat creates a message 301 for opening a chat-room in the video game machine 103a. When the message is sent, a chat-room open request 302 is sent to the message server group 113. The message server group 113 sends a open room setting 303 for opening a requested chat-room to a database in server groups 113 and also returns a chat-room open response 304 to the user. Starting a chat-room means that the message server group 113 sets a certain area in the database and grants an access right to specific users, that is, to chat potential participants only.

The user receives the chat-room start response 304, which is information necessary for accessing the region for chat, and then sends a chat-room entry message 305 to the database in order to enter the chat-room (in order to participate in the chat). The chat-room is entered by accessing the predetermined area in the database by applying to the message server group 113 for the access right the user has.

Further, based on the created message 301, a message 306 for inviting potential chat participants to participate in a chat, is sent to chat participants and displayed. Then, a chat invitation 307 is sent to all of the potential participants. A screen 310 for prompting to enter the chat-room is displayed on the video game machine 103b of each potential participant having received the chat invitation 307. The potential participants send a chat-room entry message 308 to the database in order to participate in the chat. Here, a chat response 309 for notifying that the potential participant has accepted the invitation of the chat-room starter is sent from the potential participants to the chat-room starter. According to the present invention, the chat invitation 307 grants to each potential participant an access right to the opened chat-room and also prompts participation into the chat.

Even after the chat-room has been opened, the chat invitation 307 can be sent to other potential chat participants. The screen 310 for prompting to enter the chat-room is displayed on a video game machine 103c of each of the potential participants having received the chat invitation 307. Then, the potential participants can send the chat-room entry message 308 to the database in order to participate in the chat. Here, a chat response 309 for notifying that the potential participant has accepted the invitation of the chat-room starter is sent from the potential participant to the chat-room starter.

A chat starter or a participant sends a message to the chat-room and the message server broadcasts the message stored in the database to the other participants and/or the starter in order to perform chat.

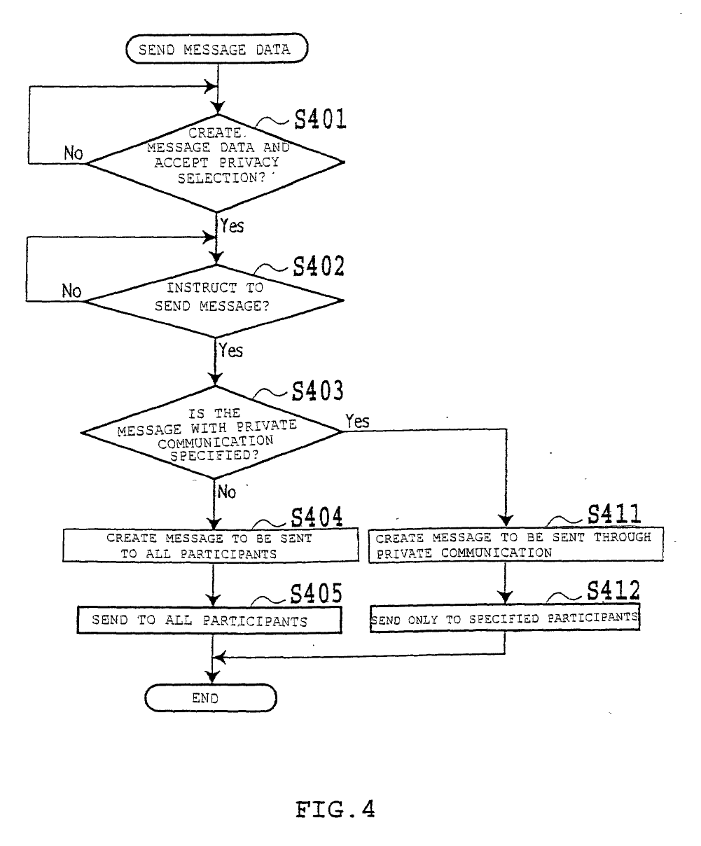

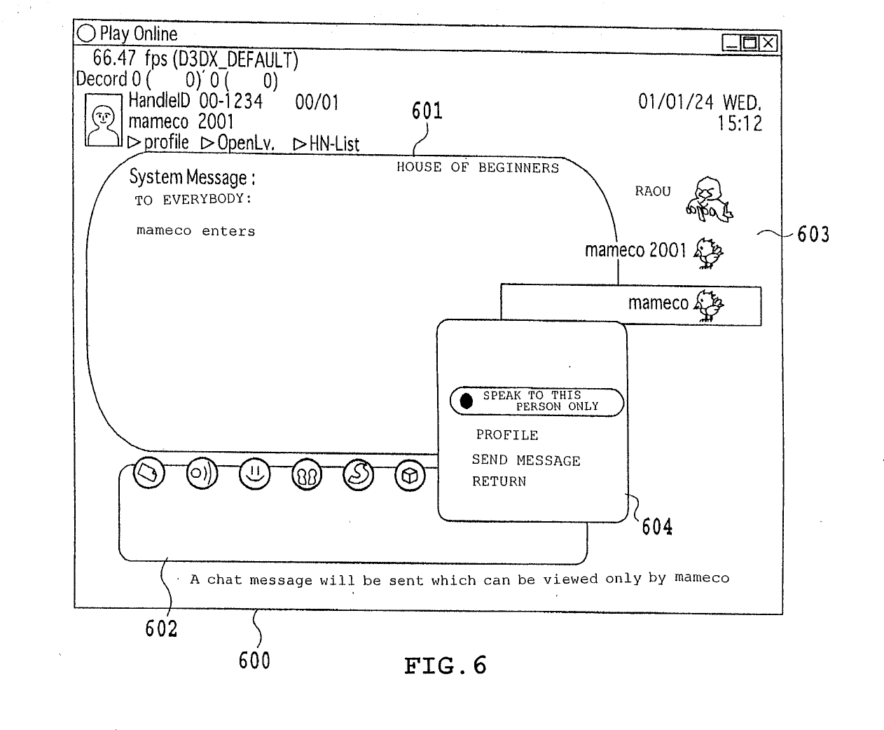

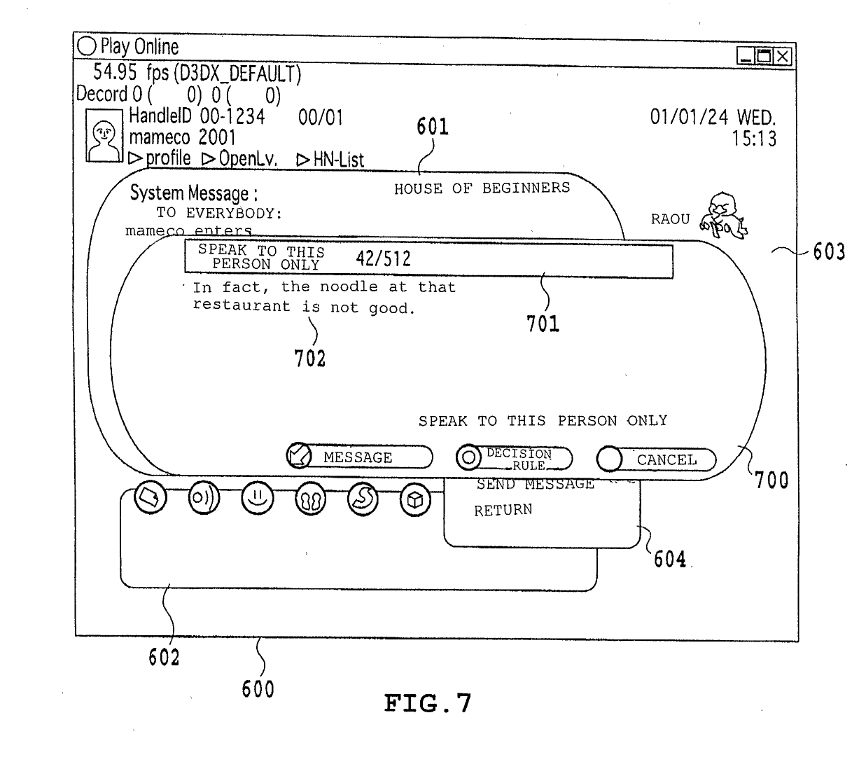

FIG. 4 is a flowchart for indicating a private communication method in a teleconference according to one embodiment of the present invention. When the participant sends a message, a source terminal accepts input including the specification of private communication, the source of the message, and an input of message data. The user inputs the information on a pop-up screen, which will be described below with reference to FIG. 6, and on a message creating screen, which will be described with reference to FIG. 7 (S401). When the participant finishes the message creation, the participant instructs the message server to send the message (S402).

The source terminal checks whether private communication has been specified(S403). If there is no specification of the private communication, a message to be sent to all participants in the chat is created and a message header and so on are added thereto based on the input message (S404). Then, the message is sent to the message server (S405), which forwards the message to all of the participants.

If the participant has specified that private communication should occur (S403), the source terminal creates a message to be sent as a private communication to the specified recipients and adds a message header and so on thereto. Then, the message is sent to the message server (S412).

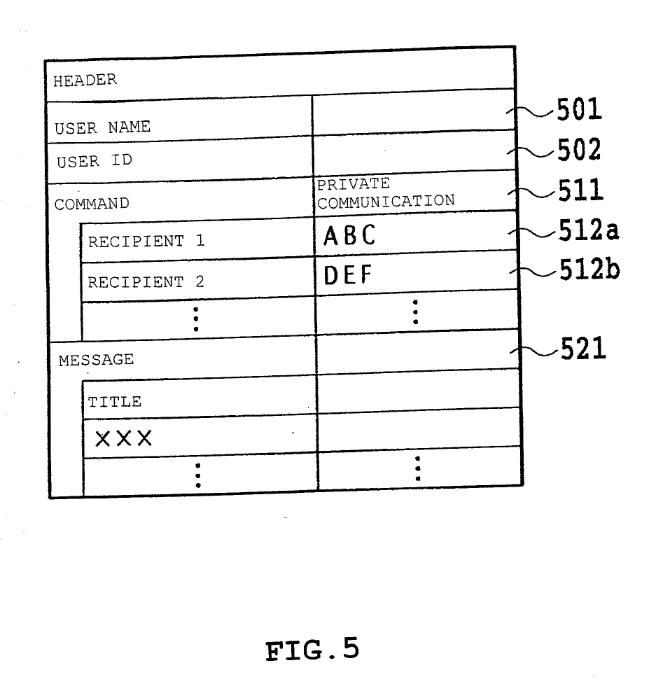

FIG. 5 is a diagram showing a communication data format for a message in a teleconference according to one embodiment of the present invention. The video game machine 103 sets a user name 501 and a user ID 502 of the pre-registered chat starter. Then, the video game machine 103 sets a message input received by one of the participants in a message field 521. If the participant specifies private communication, the video game machine 103 sets a specific flag indicating “private communication” in a command field 511. Then, information for identifying recipients specified by the participant is set in recipient fields 512a and 512b.

As such, the message server does not broadcast but sends the message, in which the specific flag is set indicating “private communication” in the command field 511, only to the starter or participants set in the recipient fields 512a and 512b.

FIG. 6 is a diagram showing a chat screen according to one embodiment of the present invention. A chat screen 600 includes a chat window 601 for displaying a message sent from the starter or one of the participants, a chat sub-command window 602 for listing functions available during chat, and a participating member table 603 listing participants.

If the participant sends a message as a private communication, the participant selects “speak to this person only” in a pop-up screen 604 which is displayed in response to the selection of receiving members in the participating member table 603. Alternatively, the participant may select the “speak to this person only” in a pop-up window, not shown, which is displayed in response to the selection of a “message” in the chat sub-command window 602. Then, the participant may specify the recipients after creating the message.

FIG. 7 is a diagram showing a message creating screen according to one embodiment of the present invention. A message creating screen 700 is displayed over the chat screen 600. The message creating screen 700 includes a message title 701 and a text box 702 that shows the contents of the message.

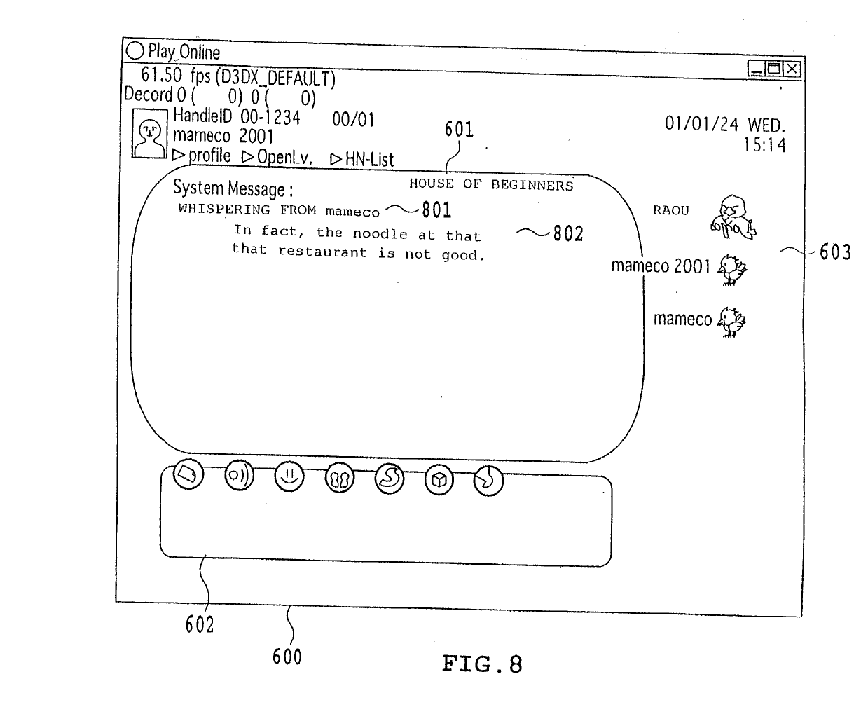

FIG. 8 is a diagram showing a chat screen displayed in response to the receipt of a private message. A message title 801 and a text box 802 which shows the contents of the message are displayed in the chat window 601 of the chat screen 600. A terminal having received the message refers to the header of the message shown in FIG. 5. If the specific flag indicating “private communication” is set in the command field 511 of the header, the terminal adds “Whispering From XXX” to the message title 801. The participant having received the message is thus informed of the fact that the message was sent as a private communication.

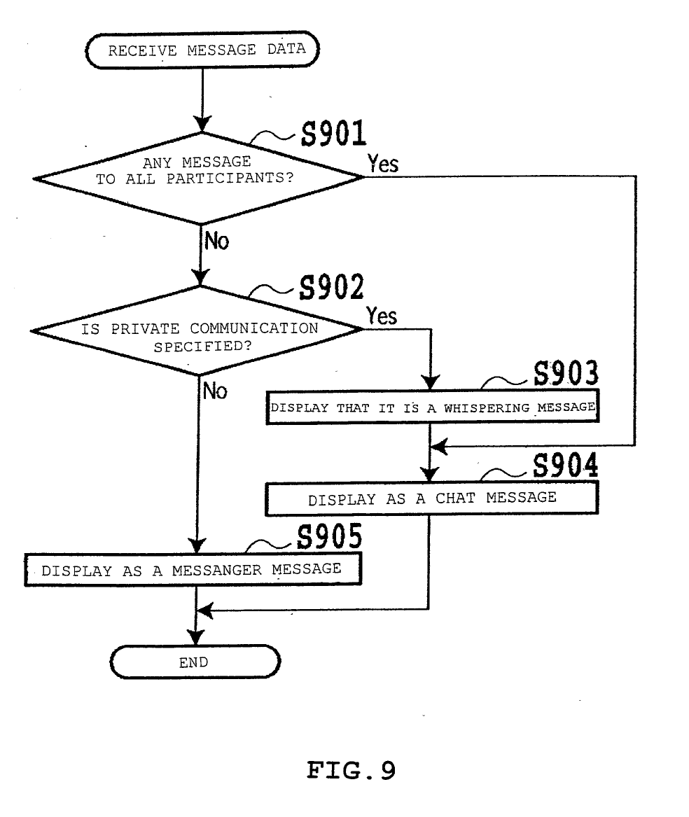

FIG. 9 is a flowchart showing another private communication method in a teleconference according to one embodiment of the present invention. A recipient terminal having received the message determines whether or not the message is sent to all of the participants or to specific participants based on the message header (S901). If the message was sent to all of the participants, the message is displayed on the chat window 601 as a general chat message (S904). If the message was sent to specific participants, the terminal checks the specific flag in the command field 511 in the data format shown in FIG. 5 (S902).

If there is the specific flag showing the “private communication” in the command field 511, the terminal refers to the recipient fields 512a and 512b and checks whether the terminal, that is the video game machine 103 in this case, itself is specified as the recipient. If so, the terminal displays the indication indicating that the message was sent through the private communication (S903) and the message as a chat message in the chat window 601 (S904).

If the specific flag is not preset in the command field 511, the message is delivered as a general message. Then, another message window is opened, and the message is displayed thereon (S905).

In this embodiment, through private communication, the message is sent only to the recipient terminals specified by the terminal sending the message. Then, in each of the recipient terminals, the indication that the message is sent through the private communication is displayed in the chat window along with the message. However, the present invention is not intended to limit to this method. The following method may be used, in other ways.

For example, even with the private communication, the source terminal sends a message along with a message header indicating the addresses of the recipients to all of the participants in the same chat. In each of the recipient terminals, the message is displayed on the screen only if the address of the recipient terminal itself is included in the message header. The recipient terminal does not display but rather discards the message if the address of the recipient terminal is not included in the message header. Thus, the source participant can perform private communication with the specified participant even in chat with many other participants.

The video game machine or the generic computer may read and execute program codes of the software for implementing the message control method according to the present invention from a recording medium for storing the program codes. The recording medium for supplying the program codes may be a floppy disk, a hard disk, a magneto-optical disk, an optical disk, a CD-ROM, a CD-R, a magnetic tape, a non-volatile memory card, or a ROM.

Further, the teleconferencing starting method and message control method according to the present invention can be applied not only to a general stand-alone computer, but also to a client-server system including multiple computers.

What is claimed is:

1. A teleconferencing method for performing a teleconference by using an area set in a database in a server, comprising:
causing a source terminal to add to a message, a header including a flag indicating whether the message is sent as a private communication and information for identifying a recipient of the message, and to send the message to the server;
causing the server to transfer the message, to which the flag is added, to the recipient terminal based on the information identifying the recipient; and
causing the recipient terminal to display the message transferred from the server terminal, along with information indicating the private communication.

2. A message control method for causing a server to provide a private communication service in a teleconference, comprising:
receiving a message from a source terminal, to which message a header including a flag indicating whether the message is sent as a private communication and information for identifying a recipient terminal is added; and
transferring to the recipient terminal the received message, based on the information identifying the recipient terminal.

3. A message control method for performing private communication among terminals participating in a teleconference by using an area set in a database in a server, comprising:
causing a source terminal to add to a message a header including a flag indicating whether the message is sent as a private communication and information for identifying a recipient of the message, and to send the message to the server terminal; and
causing the recipient terminal to display the message transferred from the server terminal, along with information indicating the message is sent as the private communication.

4. The message control method according to claim 3, wherein the source terminal receives a private communication selection that selects whether the message is sent as the private communication and a recipient selection indicating the recipient of the message transferred as the private communication, and creates the header based on the private communication selection and the recipient selection.

5. The message control method according to claim 3, wherein the recipient terminal displays the message, and the information that the message is sent as the private communication on the same display area where a general message is displayed.

6. A teleconferencing system for performing a teleconference by using an area set in a database in a server, comprising:
a source terminal comprising a sending system that sends a message to the server, while adding a header to the message, the header including a flag indicating whether the message is sent as private communication and information for identifying a recipient of the message;
the server comprising transferring system that transfers to the recipient terminal the message to which the flag is added, based on the information identifying the recipient; and
the recipient terminal comprising a display system that displays the message transferred from the server terminal, along with information indicating the message is sent as the private communication.

7. A server for providing a private communication service in a teleconference, comprising:
a receiver that receives from a source terminal a message to which a header including a flag indicating whether the message is sent as a private communication and information for identifying a recipient; and
a transferring system that transfers to the recipient the received message, to which the flag indicating the message is sent as the private communication is added, based on the information identifying the recipient.

8. A system including terminals participating in a teleconference by using an area set in a database in a server, comprising:
a source terminal comprising a sending system that sends a message to the server, while adding to the message a header including a flag indicating whether the message is sent as private communication and information for identifying a recipient of the message; and
a recipient terminal comprising a display system that displays the message transferred from the server, along with information indicating the message is sent as the private communication.

9. A computer-readable recording medium on which is recorded a program for controlling a server for providing a private communication service in a teleconference and for causing a computer to execute:
receiving from a source terminal a message to which a header is added including a flag indicating whether the message is sent as a private communication and information for identifying a recipient; and
transferring to a recipient terminal the received message, to which the flag indicating that the message is sent through the private communication is added, based on the information identifying the recipient.

10. A computer readable recording medium on which is recorded a program for controlling a plurality of terminals for performing a private communication service in a teleconference and for causing a computer to execute:
sending to a server a message, while adding to the message a header including a flag indicating whether or not the message is sent as private communication and information for identifying a recipient of the message; and
displaying the message received from the server, along with information that the message is sent as the private communication.

11. The computer-readable recording medium according to claim 10, wherein, in sending the message to the server, a source terminal accepts a private communication selection indicating whether the message is sent through the private communication or not and a recipient selection indicating the recipient of the message in the private communication, and creates the header based on the private communication selection and the recipient selection.

12. The computer readable recording medium according to claim 10, wherein, in displaying the message received from the server, a recipient terminal displays the message, to which the flag indicating that the message is sent through the private communication is added, and the information that the message is sent as the private communication on the same display area where a general message is displayed.

13. A teleconferencing method for performing a teleconference with a server and a plurality of terminals, the server transferring a message sent from one of the terminals to the other terminals, each of the other terminals displaying cumulatively a scrolled message display screen each time the transferred message is received, the method comprising;
causing a source terminal to accept a private communication selection indicating whether the message is sent as a private communication and a recipient selection indicating a recipient of the message in the private communication, to create and to send a privacy message when the private communication selection exists or a general message when there is no the private communication selection;
causing the server to transfer the general message to all of the terminals participating in the teleconference or to transfer the privacy message to the recipient terminal; and
causing the terminal to display the general message on a display area of the message display screen or to display the privacy message on the display area along with information indicating that the privacy message is private communication.
